(19) United States
(12) Patent Application Publication
(10) Pub. No.: US 2005/0201534 A1
(43) Pub. Date: Sep. 15, 2005

(54) Method for call screening in a voice mail system

(76) Inventor: Gary R. Ignatin, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 10/938,095

(22) Filed: Sep. 10, 2004

Related U.S. Application Data
(60) Provisional application No. 60/551,928, filed on Mar. 10, 2004.

(51) Int. Cl. H04M 1/64

(52) U.S. Cl. 379/88.22; 379/88.12

(57) ABSTRACT

Methods of call screening in a voice mail system are provided. In one embodiment, the method may comprise, for example, one or more of the following: receiving an indication of an incoming call for a voice mail system subscriber, the incoming call originating from a caller's telephone to a subscriber's telephone; indicating by the subscriber that call screening of the incoming call is desired; routing the incoming call to be recorded in a subscriber's voice mail box as a caller's voice message; and initiating call screening of the caller's voice message by establishing a three-way connection between the caller's telephone, the subscriber's telephone, and the centralized voice mail system, the subscriber's telephone being in a “mute” mode.

### RELATED APPLICATIONS

This application makes reference to, claims priority to, and claims the benefit of U.S. Provisional Patent Application Ser. No. 60/551,928, entitled “Method For Call Screening In A Voice Mail System” (Attorney Docket 15326US01 BP-3382), filed Mar. 10, 2004, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Centralized voice mail systems have been widely used to store and retrieve telephone calls for many years, and telephone answering machines have been used for this purpose perhaps even longer. One of the features long offered on standard answering machines (and enjoyed by users) has been the ability to “screen” calls—namely, the ability of the call recipient to listen to an incoming message while it is being left by the caller, and to interrupt the recording to initiate a two-way conversation if the recipient desires. This feature was fairly straightforward to implement in traditional answering machines, because the call recording functionality, call playback functionality, and the call recipient were all at the same physical location. The machine could simply play aloud what it was recording, and if the user was within earshot, the user could screen the call.

Centralized voice mail systems offer many advantages over traditional answering machines, such as ease of access from multiple locations, increased memory, etc. One of the drawbacks, however, of moving to a centralized call storage and retrieval system has been the loss of the popular “call screening” feature. In general, the call was being recorded at a centralized location, the user was at another unknown location, and there was no physical answering machine involved. Therefore the traditional “answering machine” method for call screening does not work on voice mail systems.

There are several other drawbacks related to the use of a centralized voice mail system with a cellular or a non-cellular telephone. In most voice mail systems today, calls are transferred to voice mail if the user fails to pick up the phone after a certain number of rings (usually a user-defined parameter), or if the phone is turned off, or if the user has otherwise set the phone to immediately invoke voice mail.

For example, if a home non-cellular telephone receives an incoming call, the call is usually switched to voice mail after several rings (as defined by the user.) Unless the non-cellular telephone has Caller ID, the recipient will not know who the caller was until after the call has ended and the recipient has called voice mail to listen to the message left by the caller. In addition, the home non-cellular telephone user does not usually know if there is a message left in voice mail unless the user picks up the telephone receiver and hears a specific dial tone alerting the user for the presence of such voice mail. Even though the non-cellular telephone user may have Caller ID, the recipient of the call may not know the subject matter of the call.

Cellular telephones usually offer the convenience of Caller ID service. However, there are still shortcomings related to the use of a centralized voice mail in cellular networks. A cellular phone user may receive a call and the Caller ID may display the caller's name and telephone number. After several rings, the caller is usually directed to voice mail to leave a message. The call recipient may then try and call back the caller, but since the caller is still leaving a message, there will be no connection. Alternatively, at the same time the caller is leaving a voice mail message, the recipient may dial back the caller's telephone and the caller may then hear an audible notification that there is an incoming call. The caller may then switch to the incoming call, but without hanging up on the call-in-progress that was placed to the recipient's voice mail. As a result, an “empty” call will be recorded in the recipient's voice mail, which, often times, is very long in duration due to the delayed “time-out” parameter of the centralized voice mail.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be found in a method of remote screening of calls in a centralized voice mail system. Such a method may comprise receiving an incoming call for a subscriber telephone, receiving a call screening enablement signal from the subscriber telephone, and muting a voice signal from the subscriber telephone. The method may also comprise recording the incoming call to a voice mailbox associated with the subscriber while playing the incoming call to the subscriber telephone. A representative embodiment of the present invention may comprise terminating recording and initiating two-way communication between the incoming call and the subscriber telephone, if a call screening disablement signal is received. Such a method may continue recording the incoming call to a voice mailbox associated with the subscriber while playing the incoming call to the subscriber telephone, if a call screening disablement signal is not received. The subscriber telephone may comprise one of a conventional telephone, a cellular telephone, and an Internet protocol (IP) phone, and the voice mailbox may be located within the subscriber telephone.

Additional aspects of the present invention may be seen in a method of remote screening of calls in a centralized voice mail system in which the method comprises receiving an incoming call for a first subscriber telephone, alerting a second subscriber telephone of the incoming call, and receiving a call screening enablement signal from the second subscriber telephone. The method may mute a voice signal from the second subscriber telephone, and record the incoming call to a voice mailbox associated with the subscriber while playing the incoming call to the second subscriber telephone. The method may also comprise terminating recording and initiating two-way communication between the incoming call and the second subscriber telephone, if a call screening disablement signal is received, and continuing recording of the incoming call, if a call screening disablement signal is not received. The first subscriber telephone may comprise one of a conventional telephone, a cellular telephone, and an Internet protocol (IP) phone, and the second subscriber telephone may comprise one of a conventional telephone, a cellular telephone, and an Internet protocol (IP) phone. The voice mailbox may be located within the first subscriber telephone, and the alerting may comprise at least one of an audible and a visual alert.

Yet other aspects of the present invention may be observed in a method of screening calls in a centralized voice mail system. Such a method may comprise receiving an indication of an incoming call for a voice mail system subscriber, where the incoming call may originate from a caller's telephone to a subscriber's telephone, and accepting an indication from the subscriber that call screening of the incoming call is desired. A representative embodiment of the present invention may also comprise routing the incoming call to be recorded in a subscriber's voice mail box as a caller's voice message. In addition, such an embodiment may comprise initiating call screening of the caller's voice message by establishing a three-way connection between the caller's telephone, the subscriber's telephone, and the centralized voice mail system. Voice signals from the subscriber's telephone may be muted. The subscriber may receive the indication of the incoming call on the subscriber's telephone, and the subscriber may receive the indication of the incoming call on a remote telephone. In another representative embodiment of the present invention, the three-way connection may be established between the caller's telephone, the remote telephone, and the centralized voice mail system. Voice signals from the remote telephone may be muted.

In a representative embodiment in accordance with the present invention, the subscriber may receive the indication of the incoming call via the Internet, and the indication of the incoming call may be at least one of a visual indication and an audible indication. In some representative embodiments of the present invention, the subscriber's voice mail box may be part of a functionality present on the subscriber's telephone, and in other representative embodiments of the present invention, the subscriber's voice mail box may be part of a functionality present on the remote telephone. A representative embodiment of the present invention may also comprise storing the caller's voice message as an audio file in the subscriber's voice mail box on the remote telephone, and transferring the audio file from the subscriber's voice mail box on the remote telephone to a voice message storage location on the centralized voice message system The audio file may be accessible for subsequent review by the subscriber. The caller's voice message may be automatically recorded in the subscriber's voice mail box without initiating the call screening, and the automatic recordation may be based on at least one of the caller's name and the caller's telephone number. The indication of the incoming call may comprise at least one of the caller's name and the caller's telephone number, and call screening of the incoming call may be initiated automatically based on at least one of the caller's name and the caller's telephone number.

In a representative embodiment of the present invention, the three-way connection may be established using at least one of a wired network connection and a wireless network connection. Such an embodiment may also comprise initiating a two-way call between the caller and the subscriber by removing the centralized voice mail system from the three-way connection and un-muting the subscriber's telephone. The initiating of the two-way call may be at the subscriber's choice. A representative embodiment of the present invention may also comprise interrupting call screening of the caller's voice message by removing the subscriber's telephone from the three-way connection. The removing of the subscriber's telephone may be at the subscriber's choice. Such a method may also comprise saving the caller's voice message in the subscriber's voice mail box for subsequent access by the subscriber. During the call screening, the caller's voice message may be an audible message heard on the subscriber's telephone, and the caller's voice message may be converted from speech to text. The text may be displayed on the subscriber's telephone.

Further aspects of the present invention may be found in a method of remote screening of calls in a centralized voice mail system, where the method comprises receiving an incoming call to a voice mail system subscriber. The call may originate from a caller's telephone to the subscriber's telephone, and the subscriber may be already engaged in an existing conference call on the subscriber's telephone. The method may also comprise initiating a recording of the incoming call as a caller's voice message into a subscriber's voice mail box, and converting the caller's voice message from speech to text. The conversion may be performed during the recording of the caller's voice message. A representative embodiment may also comprise displaying the converted text message on the subscriber's telephone. The displaying may be performed during the conversion of the caller's voice message. A representative embodiment of the present invention may initiate a two-way call between the caller and the subscriber, and the initiating of the two way call may be at the subscriber's choice. Such an embodiment may also initiate a recording of the existing conference call into the subscriber's voice mail box, where the initiating of the recording may be performed automatically after initiating the two-way call.

Additional aspects of the present invention may be seen in a system supporting the remote screening of calls. Such a system may comprise at least one processor capable of receiving an incoming call for a subscriber telephone, and the at least one processor may be capable of receiving a call screening enablement signal from the subscriber telephone. The at least one processor may also be capable of muting a voice signal from the subscriber telephone, and of recording the incoming call to a voice mailbox associated with the subscriber while playing the incoming call to the subscriber telephone. The at least one processor may be capable of terminating recording and initiating two-way communication between the incoming call and the subscriber telephone, if a call screening disablement signal is received. The at least one processor may be capable of continuing recording the incoming call to a voice mailbox associated with the subscriber while playing the incoming call to the subscriber telephone, if a call screening disablement signal is not received. In a representative embodiment of the present invention, the subscriber telephone may comprise one of a conventional telephone, a cellular telephone, and an Internet protocol (IP) phone, and the voice mailbox may be located within the subscriber telephone.

Yet other aspects of the present invention may be observed in a system supporting the remote screening of calls, in which the system comprises at least one processor capable of receiving an incoming call for a first subscriber telephone. The least one processor may be capable of alerting a second subscriber telephone of the incoming call, and of receiving a call screening enablement signal from the second subscriber telephone. In addition, the least one processor may be capable of muting a voice signal from the second subscriber telephone, and of recording the incoming call to a voice mailbox associated with the subscriber while playing the incoming call to the second subscriber telephone. The least one processor may be capable of terminating recording and initiating two-way communication between the incoming call and the second subscriber telephone, if a call screening disablement signal is received. The least one processor may also be capable of continuing recording of the incoming call, if a call screening disablement signal is not received. The first subscriber telephone may comprise one of a conventional telephone, a cellular telephone, and an Internet protocol (IP) phone, and the second subscriber telephone may comprise one of a conventional telephone, a cellular telephone, and an Internet protocol (IP) phone. The voice mailbox may be located within the first subscriber telephone, and the alerting may comprise at least one of an audible and a visual alert.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1A is a block diagram of an exemplary communication network in which a representative embodiment in accordance with the present invention may be practiced.

FIG. 1B is a block diagram of an exemplary communication network in which another representative embodiment in accordance with the present invention may be practiced.

FIG. 1C is a block diagram of an exemplary communication network in which another representative embodiment in accordance with the present invention may be practiced.

FIG. 2A is a flow diagram of an exemplary method for call screening in a communication network such as, for example, the communication networks of FIGS. 1A, 1B, and 1C, in accordance with a representative embodiment of the present invention.

FIG. 2B is a flow diagram of an exemplary method for call screening in a communication network such as, for example, the communication networks of FIGS. 1A, 1B, and 1C, in accordance with another representative embodiment of the present invention.

FIG. 2C is a flow diagram of an exemplary method for call screening in a communication network such as, for example, the communication networks of FIGS. 1B and 1C, in accordance with a representative embodiment of the present invention.

FIG. 2D is a flow diagram of an exemplary method for call screening in a communication network such as, for example, the communication network of FIGS. 1B and 1C, in accordance with a representative embodiment of the present invention.

FIG. 3A is a block diagram of an exemplary communication network with voice mail functionality present on at least one network element, in accordance with a representative embodiment of the present invention.

FIG. 3B is a flow diagram of an exemplary method 300B for late call screening in a communication network such as, for example, the communication networks of FIGS. 1A, 1B, and 1C, in accordance with another representative embodiment of the present invention.

FIG. 4 is a block diagram of an exemplary communication network utilizing “silent screening” functionality during call screening, in accordance with representative embodiment of the present invention.

### DETAILED DESCRIPTION OF THE INVENTION

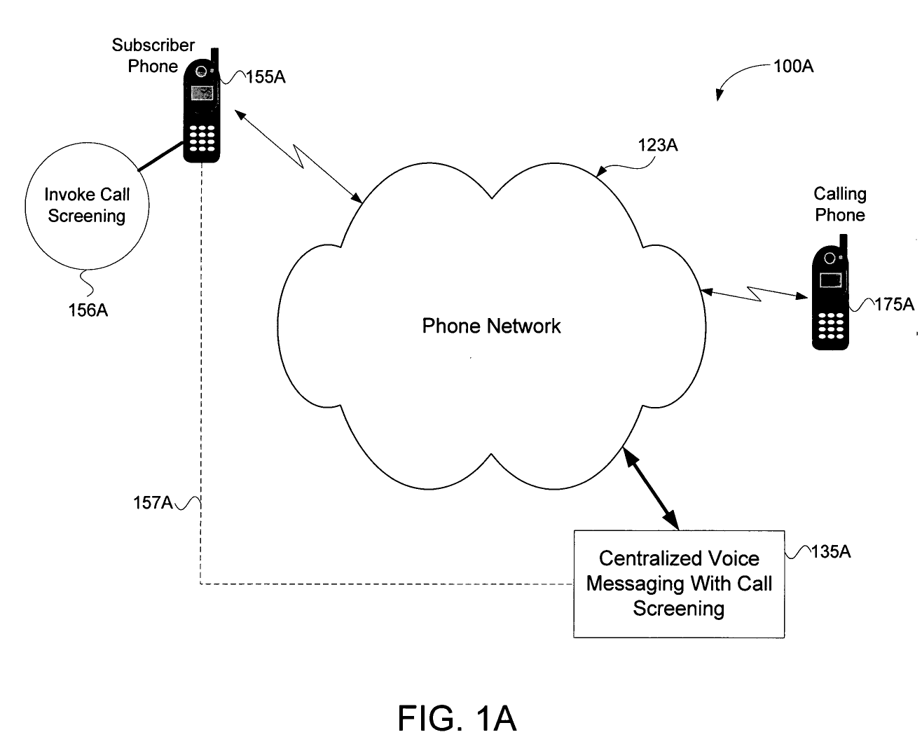

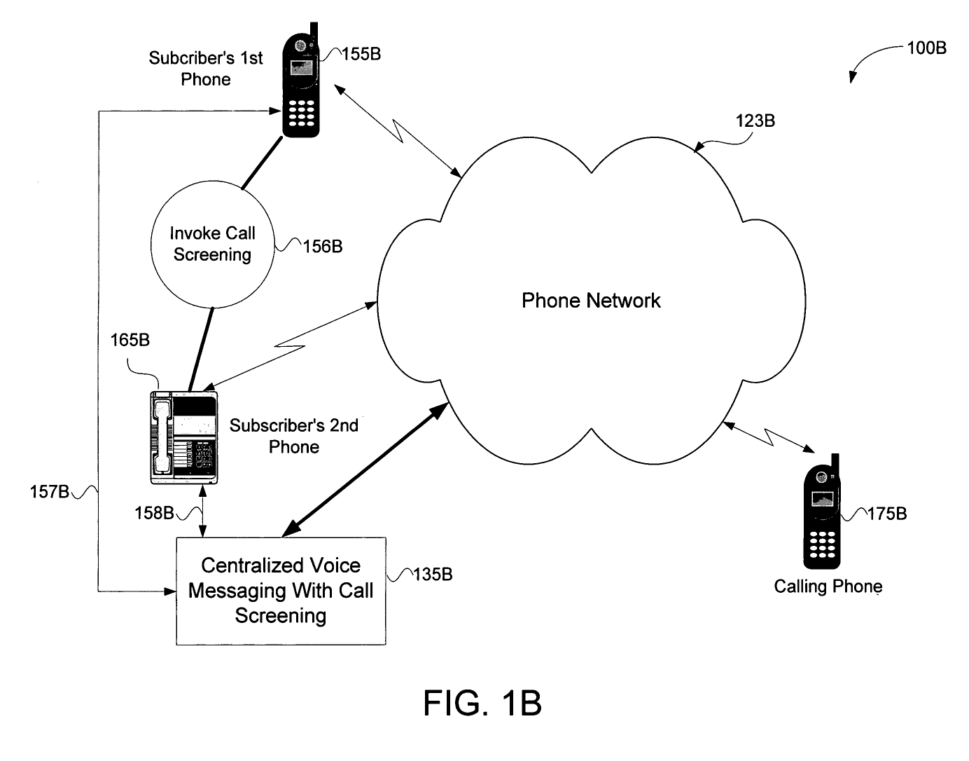

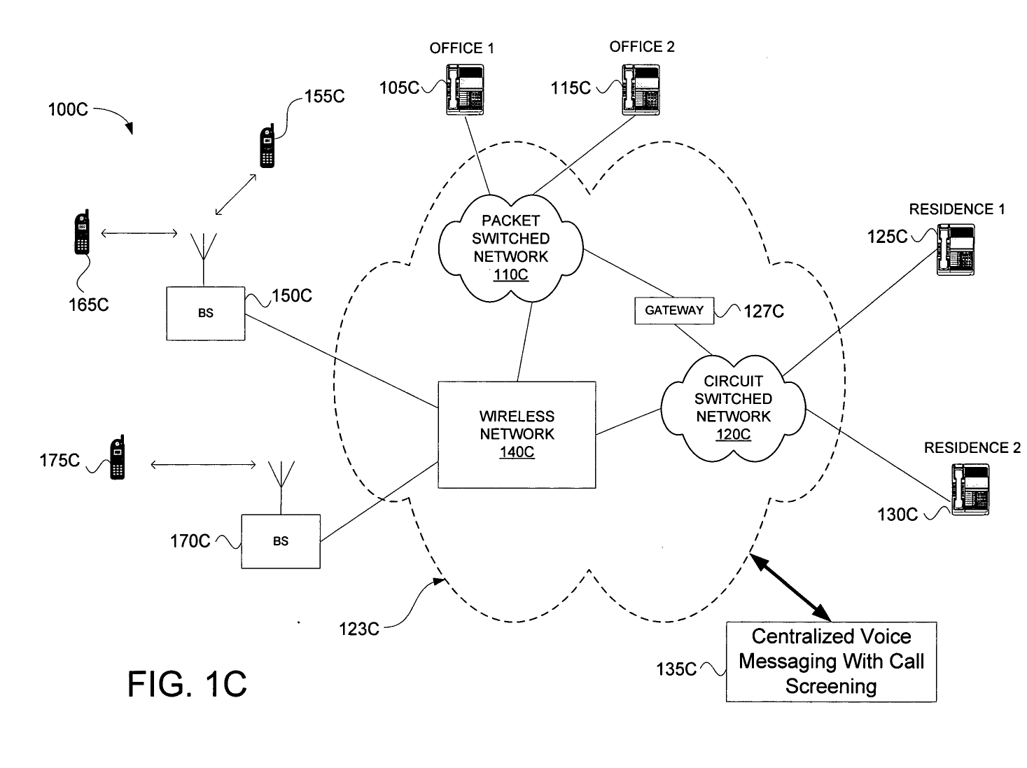

FIG. 1A is a block diagram of an exemplary communication network 100A in which a representative embodiment in accordance with the present invention may be practiced. The communication network 100A comprises a representative wireless (i.e. cellular) telephone 155A communicating with a respective phone network 123A (in this instance a wireless network). Although the communication network 100A illustrated in FIG. 1A is shown as a wireless network, the present invention is not limited in this regard. The communication network in a representative embodiment of the present invention may comprise either a wireless or wired network, without departing from the scope of the present invention. The phone network 123A has associated with it a centralized voice messaging system 135A, which includes the various call screening functionality of the present invention. According to this embodiment, a user might receive a call on subscriber wireless telephone 155A (for instance), and desire to invoke certain call screening functionality via an operation 156A which might include a specialized button, or keystroke on a keypad. A signal could be sent from wireless telephone 155A through the phone network 123A to the centralized voice messaging system 135A, thereby indicating the desire for call screening. Alternatively the centralized voice messaging system 135A might be directly associated with the subscriber wireless telephone 155A, and a call screening invocation could be sent via connection 157A. Once the call screening has been invoked, through whichever means, the wireless telephone 155A would be automatically muted and the user would be able to listen to the incoming message, while it is presently being left by the caller on phone 175A. The user can then send another signal to pick up the call, in the middle of it being recorded, if the user desires to speak (immediately) with that particular caller.

FIG. 1B is a block diagram of an exemplary communication network 100B in which another representative embodiment in accordance with the present invention may be practiced. The communication network 100B comprises a representative subscriber's first telephone 155B, and a subscriber's second telephone 165B, communicating with a respective phone network 123B. In the illustration of FIG. 1B, the subscriber's first telephone 155B is a wireless (e.g., cellular) telephone, the subscriber's second telephone 165B is a wired (e.g., circuit switched, packet switched) telephone, and phone network 123B supports communication with both. The present invention is not limited to the arrangement illustrated in FIG. 1B, and other combinations of wired and wireless telephony devices may be employed without departing from the spirit and scope of the present invention. The phone network 123B has associated with it a centralized voice messaging system 135B, which includes the various call screening functionality of the present invention. According to this embodiment, a user might receive a call on subscriber's first telephone 155B (for instance) while the subscriber is located at subscriber's second telephone 165B. The subscriber may be notified at subscriber's second telephone 165B of the receipt of the call at subscriber's first telephone 155B. In another scenario, the incoming call may be received at subscriber's second telephone 165B while the subscriber is located at subscriber's first telephone 155B, and the subscriber may be notified at subscriber's first telephone 155B of the receipt of the call at subscriber's second telephone 165B. In either scenario, the subscriber may desire to invoke certain call screening functionality via an operation 156B which might, for example, include a specialized button, or keystroke on a keypad. In such an event, a signal could be sent from the telephone at the location of the subscriber, through the phone network 123B to the centralized voice messaging system 135B, thereby indicating the desire for call screening. Alternatively the centralized voice messaging system 135B might be directly associated with the subscriber telephones 155B, 165B, and a call screening invocation could be sent via connections 157B, 158B, respectively. Once the call screening has been invoked, through whichever means, the telephone at the location of the subscriber would be automatically muted, and the user would be able to listen to the incoming message, while it is presently being left by the caller on phone 175B. The user can then send another signal to disable call screening and pick up the call, in the middle of it being recorded, if the user desires to speak (immediately) with that particular caller.

FIG. 1C is a block diagram of an exemplary communication network 100C in which another representative embodiment in accordance with the present invention may be practiced. Aspects of the communication network 100C may correspond to, for example, the communications networks 100A and 100B illustrated in FIGS. 1A and 1B, respectively. The communication network 100C comprises telephones 105C, 115C, 125C and 130C, wireless telephones 155C, 165C and 175C, and wireless base stations 150C and 170C. The telephones and base stations are supported via a voice network 123C comprising packet switched network 110C, a circuit switched network 120C, a gateway 127C, a wireless network 140C. The network 100C also comprises a centralized voice messaging system 135C.

The telephones 105C and 115C are connected to the packet switched network 110C, and the telephones 125C and 130C are connected to the circuit switched network 120C. The packet switched network 110C and the circuit switched network 120C are connected via the gateway 127C. Wireless base station 150C provides service to wireless telephones 155C and 165C, and wireless base station 170C provides service to wireless telephone 175C. The wireless base stations 150C and 170C and the circuit switched network 120C are all connected via a wireless network 140C. The telephones 105C, 115C, 125C and 130C on the communication network 100C may be utilized in different user locations. For example, telephones 125C and 130C may be located at first and second user residences, respectively. Similarly, telephones 105C and 115C may be located at a first and second office locations, respectively. All of the telephones utilized on the communication network 100C utilize a representative centralized voice mail system with the call screening capabilities of the present invention, as shown by block 135C.

In a representative embodiment of the present invention, when a user (a call “recipient”) of the communication network 100C receives a call, the user may indicate (for example, via a push button, a touch screen command, a voice command) that they wish to screen the call. For example, a caller on a wireless telephone 155C may initiate a call to a recipient at telephone 125C at the first residence. The call will be routed from wireless base station 150C through the wireless network 140C and the circuit switched network 120C to the telephone 125C. At the time the recipient receives the call from wireless telephone 155C, the recipient may, or may not, be using telephone 125C for another call. In either case, however, the telephone 125C may be equipped with Caller ID functionality and the caller's name and/or telephone number may be alerted to the recipient. If the recipient chooses to screen the call based on this information, the recipient's telephone 125C then sends a signal to the centralized voice mail system centralized voice messaging system 135C to indicate that call screening is desired, and the system establishes a three-way connection between the phone of the caller 155C, the centralized voice mail system 135C, and the recipient's phone 125C. The recipient's telephone 125C is then automatically muted. The muting may be done by the telephone itself by temporarily disabling its microphone or voice transmission capabilities, or by the centralized voice mail system, which may block the connection between the recipient and the caller in one direction only. Once the three-way connection and muting has occurred, the recipient can listen to the incoming message freely, just as if the recipient were listening to an answering machine at home.

During the screening process, the recipient has the ability to indicate (for example, via a push button, touch screen, or voice command), that he or she would like to initiate a two-way conversation with the caller. Upon doing so, the telephone 125C sends a signal to the centralized voice messaging system 135C indicating the recipient's preference, the voice mail system drops the recording system as a “party” to the call, the recipient's telephone 155C is automatically un-muted, and the caller and recipient can conduct a regular two-way telephone conversation.

In another representative embodiment of the present invention, a recipient may be in a first office location utilizing the telephone 105C. A caller from the second residence telephone 130C may call the recipient at the recipient's second office telephone 115C. Functionality of the centralized voice mail system 135C on the communication network 100C may allow the recipient to receive a notification on telephone 105C that a caller is calling the recipient at telephone 115C. For example, telephone 105C may display caller ID information for the caller on telephone 130C. Further, the recipient may be continuously alerted on telephone 105C after the caller is redirected to the recipient's voice mail box and initiates leaving a voice message. At this point, the recipient may be offered the option to call screen while the caller is leaving a voice message. The recipient may choose to “pick up” and connect to the caller via telephone 105C, or the recipient may choose to stop the call screening.

In yet another representative embodiment of the present invention, a first recipient may redirect screening from a first telephone to a second telephone, so that the screening functionality may be utilized by a second recipient at the second telephone. For example, a caller using a wireless telephone 175C may try calling a first recipient at the first recipient's residence telephone 125C. The call is routed through the wireless base station 170C, the wireless network 140C, the circuit switched network 120C to the telephone 125C. However, a second recipient residing at the same residence as the first recipient, may have programmed telephone 125C to notify the second recipient for any incoming calls at the second recipient's office telephone 115C. The telephone 125C may display caller ID details of the caller using wireless telephone 175C. The caller ID details may then be displayed on the second recipient's office telephone 115C and the centralized voice mail system 135C may also alert the second recipient that the caller has initiated a recording of a voice message and that call screening is available. The second recipient may then forward the caller's details to the first recipient, who is using a wireless telephone 165C. The same call screening functionality may then be available to the first recipient at wireless telephone 165C, as soon as the first recipient obtains caller ID details on the incoming call and subsequent voice message recording from the caller using wireless telephone 175C.

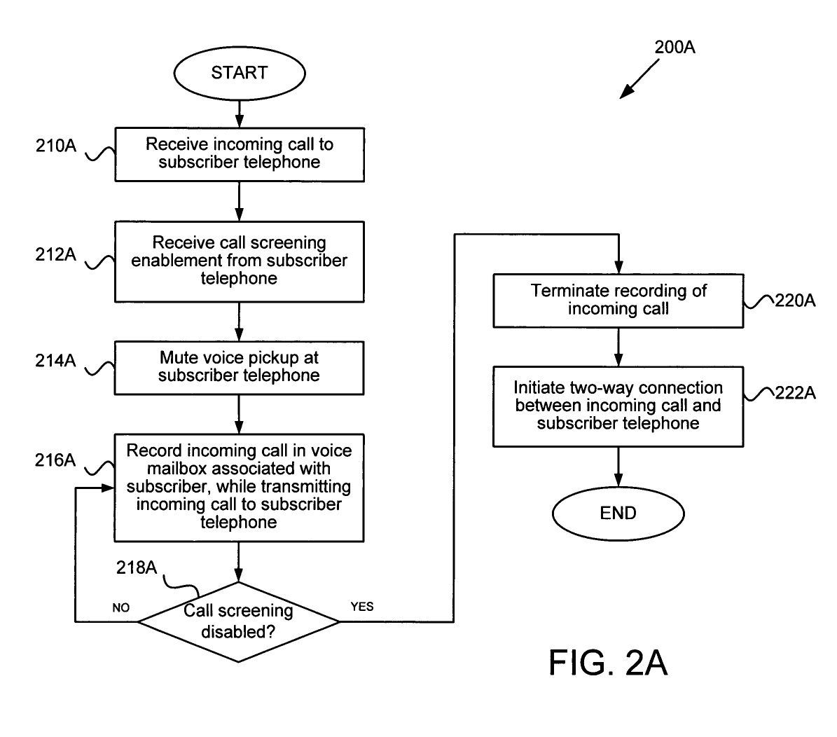

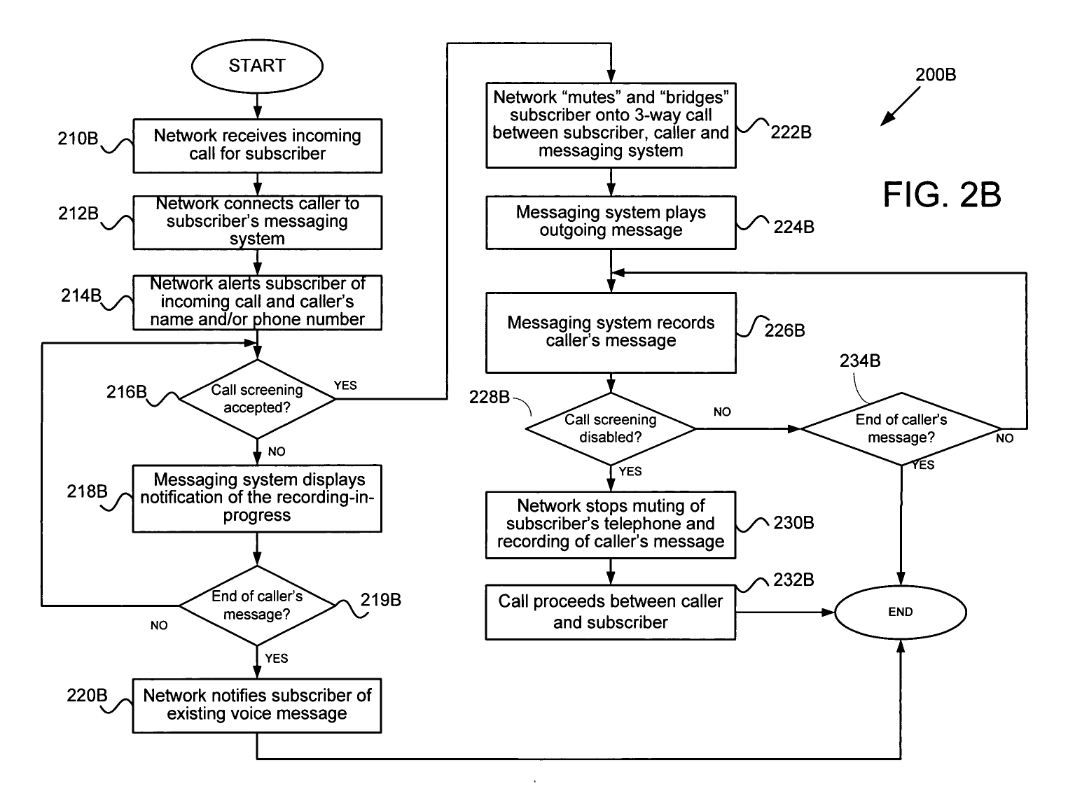

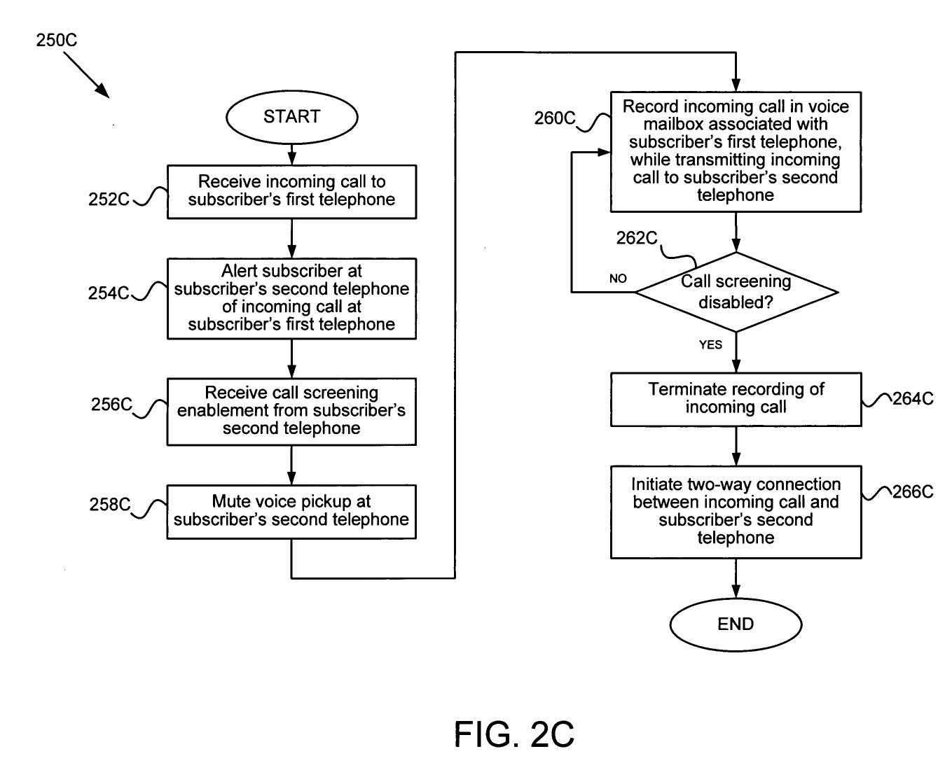

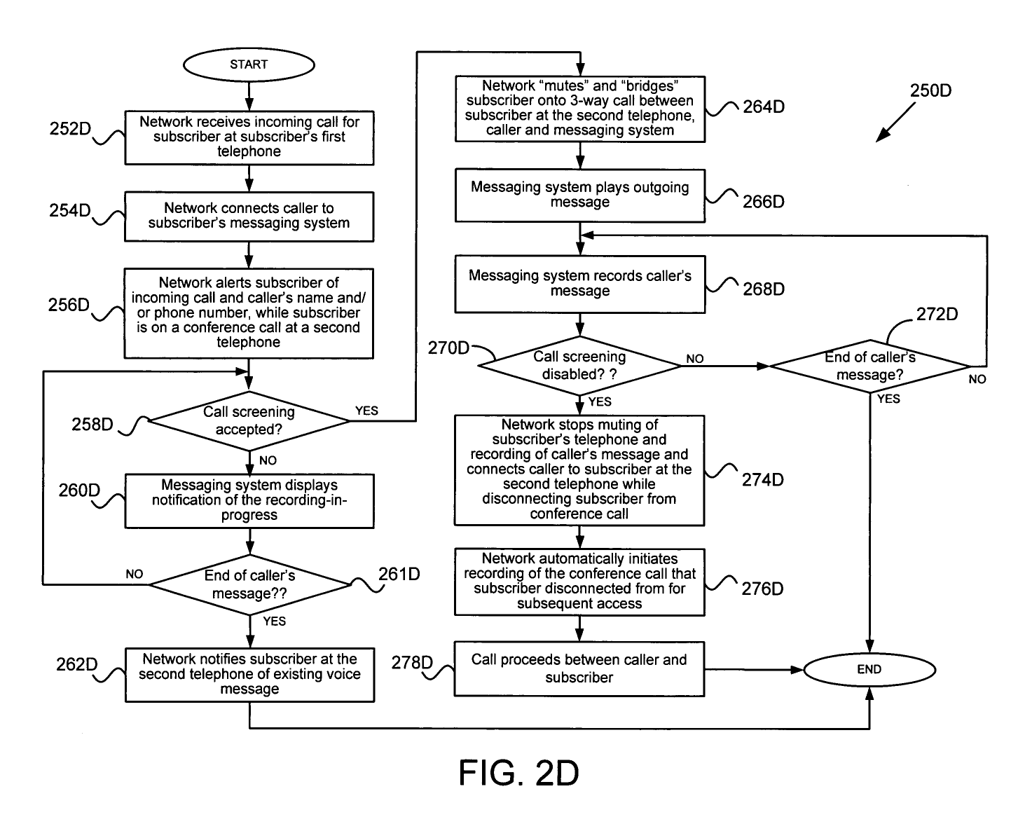

FIG. 2A is a flow diagram of an exemplary method 200A for call screening in a communication network such as, for example, the communication networks of FIGS. 1A, 1B, and 1C, in accordance with a representative embodiment of the present invention.

At 210A, a communication network such as, for example, the communications network 100C may receive an incoming call for a subscriber on the centralized voice mail network. For example, a caller from telephone 130C may call a subscriber who is utilizing a wireless telephone 155C. The subscriber of wireless telephone 155C may be engaged in a conversation with another caller, and may receive an indication of an incoming call. At 212A, the subscriber of wireless telephone 155C may desire to screen the incoming call, and centralized voice mail network may receive a call screening enablement from the subscriber using wireless telephone 155C. At 214A, the voice pickup of the wireless telephone 155C may be muted, to avoid inadvertently revealing that the subscriber of wireless telephone 155C is present on the call. At 216A, the incoming call from telephone 130C may be recorded in the centralized voice mail network voice mailbox associated with the subscriber of wireless telephone 155C, while the incoming call from telephone 130C is also transmitted to the wireless telephone 155C.

At 218A, it is determined whether call screening has been disabled by the subscriber of wireless telephone 155C. If it is determined that call screening has been disabled, at 220A the recording of the incoming call is terminated, and at 222A, a two-way connection between the caller at telephone 130C and the subscriber of wireless telephone 155C is initiated. If, however, in response to 218A, it is determined that call screening has not been disabled, the recording of the incoming call continues, while the subscriber at wireless telephone 155C listens.

FIG. 2B is a flow diagram of an exemplary method 200B for call screening in a communication network such as, for example, the communication networks of FIGS. 1A, 1B, and 1C, in accordance with another representative embodiment of the present invention.

At 210B, a communication network such as, for example, the communication network 100C may receive an incoming call for a subscriber on the centralized voice mail network. For example, a caller from telephone 130C may call a subscriber who is utilizing a wireless telephone 155C. The subscriber using wireless telephone 155C may be engaged in a conversation with another caller and as a result, the voice mail network, at 212B, may connect the caller to the subscriber's voice messaging system (i.e., the subscribers voice mail box on the centralized voice mail network). The voice mail network may obtain the caller ID information, such as the caller's name and/or telephone number. At 214B, the voice mail network alerts the subscriber at wireless telephone 155C of the incoming call and provides the collected caller ID information. The alert and the caller ID information may be transmitted to the subscriber by using, for example, the Internet, short message service (SMS) or multimedia messaging service (MMS) on a cellular telephone, or other information delivery means. In addition, the subscriber is also given the option to initiate call screening from the wireless telephone 155C. At 216B, it is determined whether the subscriber has accepted the call screening option offered by the voice mail network. If call screening is not accepted, at 218B, a notification of the recording-in-progress is displayed on the subscriber's wireless telephone 155C. At 219B, it is determined whether the caller's message has ended. If the caller's message has ended, at 220B, the messaging system notifies the subscriber of the existing message in the subscriber's voice mail box. Such notification may be a visual or audible notification, or both, at the wireless telephone 155C. If the caller's message has not ended, the messaging system continues to check, at 216B, whether the call screening has been accepted.

If call screening is initiated by the subscriber (for example by a voice command, a push-button command, or a touch-screen command), the voice mail network, at 222B, mutes the wireless telephone 155C and establishes a three-way call connection between the caller at telephone 130C, the subscriber at wireless telephone 155C, and the voice messaging system. After playing the subscriber's outgoing message greeting at 224B, the voice messaging system, at 226B, initiates the recording of the caller's voice message into the subscriber's voice mail box. At 228B, it is determined whether the subscriber wishes to disable call screening and initiate a two-way conversation with the caller. If yes, then the voice mail network, at 230B, stops muting the subscriber's wireless telephone 155C and stops the recording of the caller's voice message into the subscriber's voice mail box. The voice messaging system is then disconnected from the three-way call, and a two-way call proceeds between the caller and the subscriber, at 232B. If, in response to 228B, the subscriber is not willing to initiate a two-way call with the caller, at 234B it is determined whether the caller has finished leaving the voice message. If caller has not yet finished leaving the message, then the voice message system continues recording the voice message and displaying a notification of the recording-in-progress, at 226B. During the time that the caller's voice message is being recorded, the subscriber is offered the option to drop call screening and initiate a two-way call with the caller (at 228B).

FIG. 2C is a flow diagram of an exemplary method 250C for call screening in a communication network such as, for example, the communication networks 100B and 100C of FIGS. 1B and 1C, respectively, in accordance with a representative embodiment of the present invention. The method 250C may be useful, for example, if the subscriber is currently located in the vicinity of one telephone, while a caller is trying to reach the subscriber at another telephone.

In the following discussion, the actions of the method of FIG. 2C are illustrated with reference to the elements of FIG. 1C. The method of FIG. 2C begins when, at 252C, the communication network 100 receives an incoming call for a subscriber at a first subscriber telephone 105C on the centralized voice mail network. For example, a caller from wireless telephone 175C may call a subscriber who is normally located at subscriber's first telephone 105C. The called subscriber, however, is may be temporarily located at subscriber's second telephone 115C. At 254C, the voice mail network alerts the subscriber, who is at the subscriber's second telephone 115C, of the incoming call at the subscriber's first telephone 105C. The alert and, for example, caller ID information may be transmitted to the subscriber by using, for example, the Internet, short message service (SMS) or multimedia messaging service (MMS) on a cellular telephone, or other information delivery means. The subscriber may be given the option to enable call screening from the office telephone 115C. At 256C, user enablement of call screening is received by the voice mail network. The voice mail network, at 258C, mutes the voice pickup of the office telephone 115C. The voice mail network may then establish a three-way call connection between the caller at wireless telephone 175C, the subscriber at subscriber's second telephone 105C, and the voice messaging system 135C. At 260C, the caller's voice message is recorded into the voice mail box associated with the subscriber's first telephone 105C, while the incoming call is also transmitted to subscriber's second telephone 115C. At 262C, it is determined whether the subscriber has disabled call screening. If yes, then the voice mail network, at 264C, terminates recording of the incoming call into the subscriber's voice mail box and, at 266C, initiates a two-way connection between the caller from wireless In addition, the subscriber is disconnected from the conference call that he was previously connected to. If it is determined, at 262C, that the subscriber has not disabled call screening, then the recording of the incoming call into the subscriber's voice mailbox continues.

FIG. 2D is a flow diagram of an exemplary method 250D for call screening in a communication network such as, for example, the communication network 100B and 100C of FIGS. 1B and 1C, respectively, in accordance with a representative embodiment of the present invention. The method 250D may be useful, for example, if the subscriber is currently engaged on a conference call at one telephone and a caller is trying to reach the subscriber at another telephone.

Referring again to FIG. 1C, at 252D, the communication network 100C may receive an incoming call for a subscriber at a first subscriber telephone on the centralized voice mail network. A caller from wireless telephone 175C may call a subscriber who is utilizing an office telephone 115C. The subscriber, however, is engaged in a conference call on office telephone 105C. The voice mail network, at 254D, connects the caller to the subscriber's voice messaging system (i.e., the subscribers voice mail box on the centralized voice mail network). The voice mail network may obtain the caller ID information, such as the caller's name and/or telephone number. At 256D, the voice mail network alerts the subscriber, who is at office telephone 105C, of the incoming call at office telephone 115C and provides the collected caller ID information to the subscriber while the subscriber is participating on the conference call at office telephone 105C. The alert and the caller ID information may be transmitted to the subscriber by using, for example, the Internet, short message service (SMS) or multimedia messaging service (MMS) on a cellular telephone, or other information delivery means. In addition, the subscriber is also given the option to initiate call screening from the office telephone 105C. At 258D, it is determined whether the subscriber has accepted the call screening option offered by the voice mail network. If call screening is not accepted, at 260D, the voice mail network displays a notification of the recording-in-progress on the subscriber's office telephone 105C. At 261D, the voice mail network determines whether the caller's message has ended. If the caller's message has ended, at 262D, the voice mail network notifies the subscriber of the existing message in the subscriber's voice mail box. Such notification may be a visual or audible notification, or both, at the office telephone 105C. If the caller's message has not ended, at 258D, the voice mail network continues checking whether call screening has been accepted.

If call screening is initiated by the subscriber (for example by a voice command, a push-button command, or a touch-screen command), the voice mail network, at 264D, mutes the office telephone 105C and establishes a three-way call connection between the caller at wireless telephone 175D, the subscriber at office telephone 105C, and the voice messaging system 135C. After playing the subscriber's outgoing message greeting at 266D, the voice messaging system 135C, at 268D, may initiate the recording of the caller's voice message into the subscriber's voice mail box. At 270D, it is determined whether the subscriber wishes to initiate a two-way conversation with the caller. If yes, then the voice mail network, at 274D, stops muting the subscriber's telephone 105C and stops the recording of the caller's voice message into the subscriber's voice mail box. In addition, the subscriber is disconnected from the conference call that he was previously connected to. At 276D, the voice mail network automatically initiates a recording of the conference call that the subscriber disconnected from, so that the subscriber may later access that recording. The two-way call then proceeds between the caller and the subscriber, at 278D. If, in response to 270D, the subscriber is not willing to initiate a two-way call with the caller, at 272D it is determined whether the caller has finished leaving the voice message. If caller has not yet finished leaving the message, then the voice messaging system 135C continues recording the voice message and displaying a notification of the recording-in-progress, at 268D. During the time that the caller's voice message is being recorded, the subscriber is offered the option to drop call screening and initiate a two-way call with the caller (at 270D).

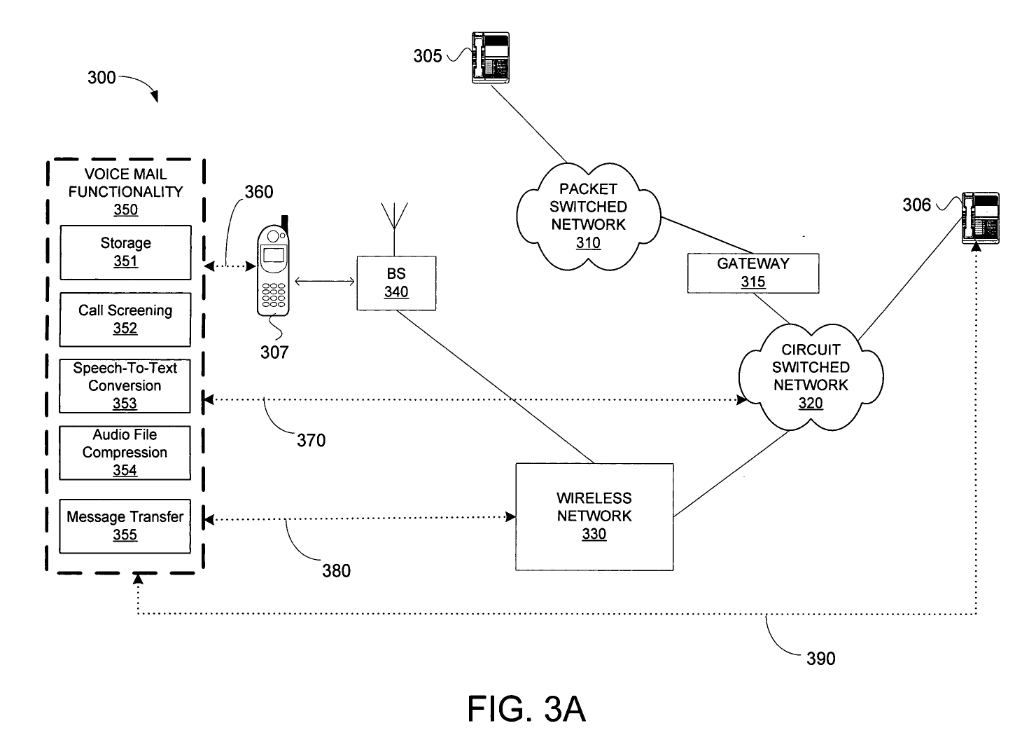

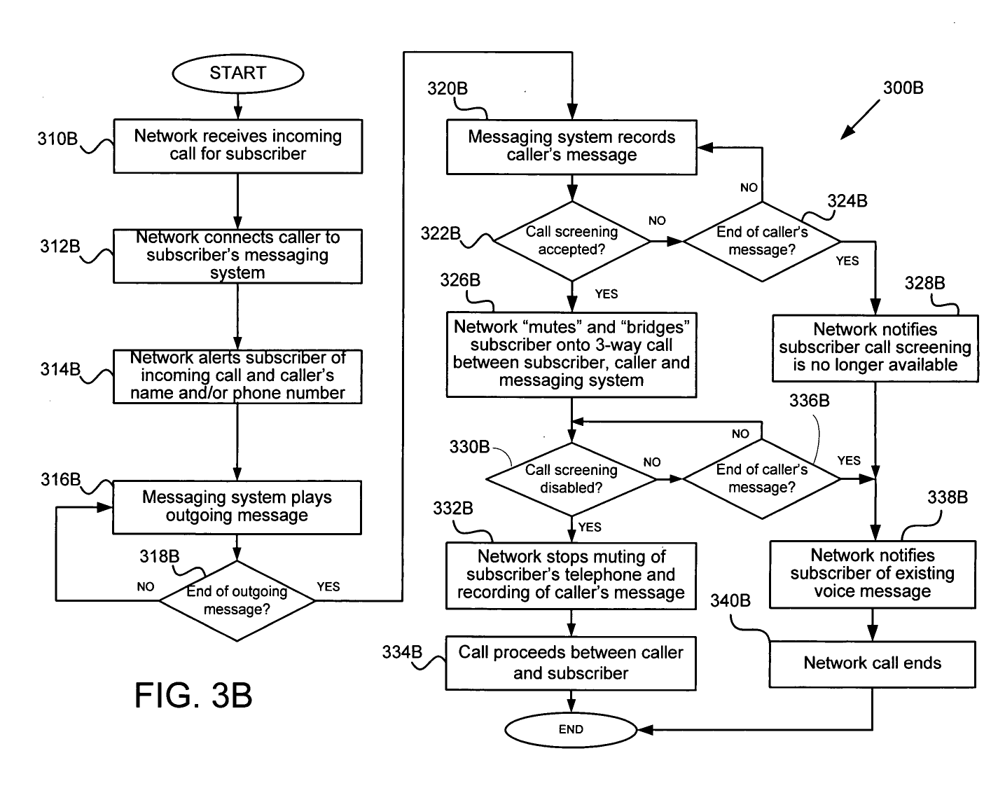

FIG. 3A is a block diagram of an exemplary communication network 300 with voice mail functionality present on at least one network element, in accordance with a representative embodiment of the present invention. The communication network 300 comprises a wireless base station 340 servicing a wireless telephone 307, a telephone 305 connected to a packet switched network 310, a gateway 315 connecting the packet switched network 310 and a circuit switched network 320, a telephone 306 connected to the circuit switched network 320, and a wireless network 330 connecting the circuit switched network 320 and the wireless base station 340.

Voice mail functionality 350 is also provided by a centralized voice mail network. The voice mail functionality 350 may include storage capabilities 351, call screening 352, speech-to-text conversion functionality 353, audio file compression functionality 354 and message transfer functionality 355. In addition, the voice mail functionality 350 may be present on any device/network that is part of the communication network 300. For example, voice mail functionality may be entirely located with the wireless telephone 307 (communication link 360) or with the telephone 306 (communication link 390). Parts of the voice mail functionality 350 may also be shared by several network elements, for example, the wireless network 330 (communication link 380) and the circuit switched network 320 (communication link 370).

In a representative embodiment of the present invention, the voice mail functionality 350 may reside entirely on the wireless telephone 307 (communication link 360 is active). If a voice message for the user of wireless telephone 307 is being recorded, then the storage 351 is utilized. For purposes of efficiency, the storage 351 may be designed to record only one message at a time. During playback of the recorded message, the wireless telephone may simultaneously connect to the centralized voice messaging system and may initiate a simultaneous recording of the voice message, while the subscriber is listening to it. After the saved message playback and simultaneous recording at a centralized voice mail storage location, the saved message may be deleted and the storage 351 cleared for a subsequent voice message.

The voice mail functionality 350 may include audio file compression capabilities 354. For example, when a caller is leaving a message for a subscriber, the voice message may be recorded in a compressed audio format, such as MP3 format, for example. Such MP3 recording may then be transferred, using the message transfer capabilities 355, from the storage 351 to a centralized voice mail storage location, or to another voice mail box on the voice mail network for retrieval by another subscriber.

Additionally, because the call screening 352 is not limited to a specific device (unlike an answering machine), this functionality can be redirected wherever the subscriber is, and over whatever device the subscriber uses. Thus, the subscriber may determine in advance that when he left his home, he would want to screen all calls to his home telephone 306 on his wireless telephone 307, or on his neighbor's telephone 305, etc. Upon a call to his home number, the voice mail system would pick up and then call the subscriber's wireless telephone 307 to indicate there was an incoming call to be screened. The subscriber would then have the option, as described above, to screen or allow the call to simply to go voice mail. The subscriber may also utilize the telephone's audio compression capabilities 354 and save the incoming voice message as a compressed MP3 audio file. The compressed audio file may then be transferred using the message transfer capabilities 355 to a centralized voice message storage location on the voice mail network.

FIG. 3B is a flow diagram of an exemplary method 300B for late call screening in a communication network such as, for example, the communication networks of FIGS. 1A, 1B, and 1C, in accordance with another representative embodiment of the present invention.

At 310B, a communication network such as, for example, the communication network 100C may receive an incoming call for a subscriber on the centralized voice mail network. For example, a caller from telephone 130C may call a subscriber who is utilizing a wireless telephone 155C. The subscriber using wireless telephone 155C may be engaged in a conversation with another caller and as a result, the voice mail network, at 312B, may connect the caller to the subscriber's voice messaging system (i.e., the subscribers voice mail box on the centralized voice mail network). The voice mail network may obtain the caller ID information, such as the caller's name and/or telephone number. At 314B, the voice mail network alerts the subscriber at wireless telephone 155C of the incoming call and provides the collected caller ID information. The alert and the caller ID information may be transmitted to the subscriber by using, for example, the Internet, short message service (SMS) or multimedia messaging service (MMS) on a cellular telephone, or other information delivery means. At 316B, the voice mail network begins playing the subscriber's outgoing message to the caller and, at 318B, it is determined whether the end of the outgoing message has been reached. If the end of the outgoing message has not yet been reached, the voice mail network continues to play the subscriber's outgoing message. If the end of the outgoing message has been reached, at 320B, the message system of the voice mail network begins recording the message of the caller from telephone 130C. At 322B, it is determined whether the subscriber at wireless telephone 155C has activated the call screening option offered by the voice mail network. If call screening is not activated, at 324B, it is determined whether the caller at telephone 130C has finished recording their message. If the end of the caller's message has not been reached, recording of the caller's message continues. If the caller's entire message has been recorded, at 328B, the voice mail network notifies the subscriber at wireless telephone 155C that call screening is no longer available and, at 338B, notifies the subscriber of the existing voice mail message. At 340B, the network call ends.

If, at 322B, call screening is initiated by the subscriber (for example by a voice command, a push-button command, or a touch-screen command) then, at 326B, the voice mail network mutes the subscriber's wireless telephone 155C and establishes a three-way call connection between the caller at telephone 130C, the subscriber at wireless telephone 155C, and the voice messaging system. It is then determined, at 330B, whether call screening has been disabled. If call screening has not been disabled, then at 336B, it is determined whether the end of the caller's message has been reached. If the end of the caller's message has been reached, at 338B, the voice mail network notifies the subscriber at wireless telephone 155C of the existing voice mail message and, at 340B, the network call ends. If, at 336B, it is determined that the end of the caller's message has not been reached, then at 330B, the voice mail network continues screening the call. If, at 330B, it is determined that the subscriber at wireless telephone 155C has disabled call screening then, at 332B the voice mail network stops the muting of the subscriber originated audio and the recording of the caller at telephone 130C, and initiates a two-way conversation between the caller at telephone 130C and the subscriber at wireless telephone 155C. The call then proceeds normally, at 334B.

Various representative embodiments may provide additional call screening features as well. For example, a phone user might set his phone ahead of time to automatically screen all calls, or to automatically record calls even after he or she answers them. Moreover, if an incoming call is received and the recipient chooses not to screen, the recipient's phone may provide an indication (via a signal from the recording system) that a message is currently being left, and the recipient would continue to have the option to initiate a “late screen” by pressing a button and initiating the procedures described above. When the caller finishes leaving the message and hangs up, the recording system would send a signal to the recipient's phone indicating such, and the phone would then indicate to the user via display or tone that screening is no longer available for that particular call. This would be particularly useful, for example, to users who are unable to answer the phone as it rings (because they are on another call, cannot reach the phone in time, or are otherwise unavailable at that moment), but who are available to screen the call within a short period of time after the phone rings.

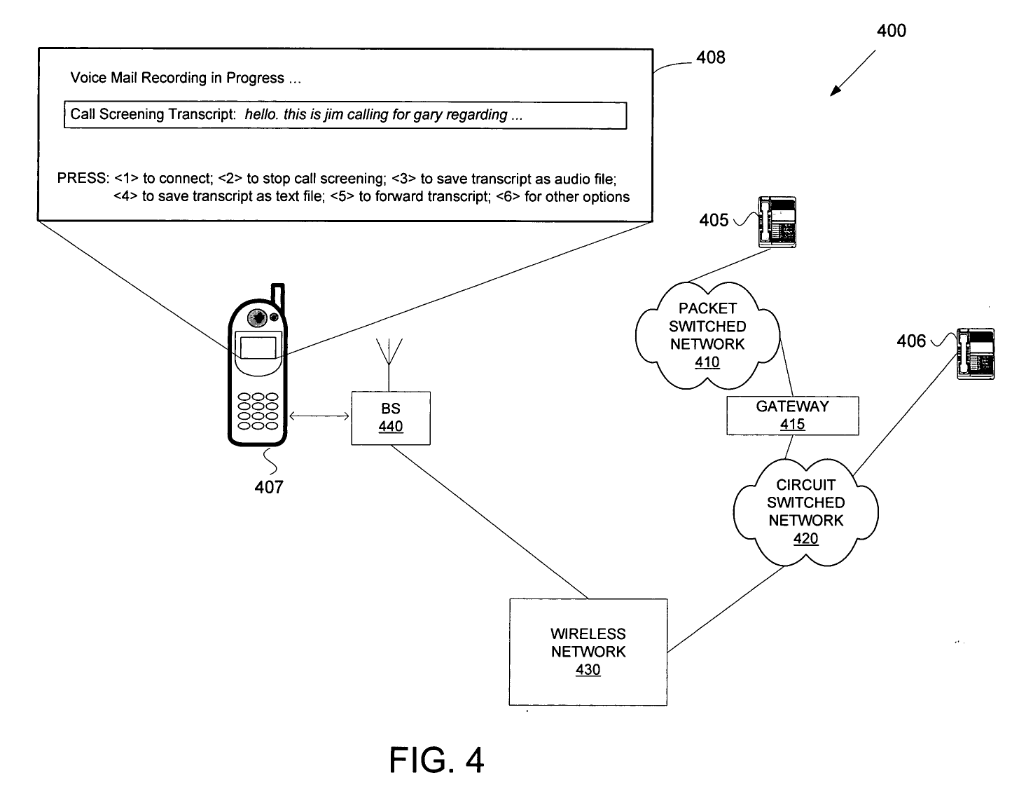

Another representative embodiment of the present invention may provide a “silent screening” functionality utilizing the speech-to-text conversion capability 353. Referring now to FIG. 4, there is illustrated a block diagram of an exemplary communication network 400 utilizing “silent screening” functionality during call screening, in accordance with a representative embodiment of the present invention. The communication network 400 comprises a wireless base station 440 servicing a wireless telephone 407, a telephone 405 connected to a packet switched network 410, a gateway 415 connecting the packet switched network 410 and a circuit switched network 420, a telephone 406 connected to the circuit switched network 420, and a wireless network 430 connecting the circuit switched network 420 and the wireless base station 440.

If call screening is initiated at the wireless telephone 407, the subscriber using this telephone may utilize “silent screening”—namely, when an incoming call to the subscriber is sent to voice mail, the voice message recording system may not only record the caller's message, but may simultaneously convert the message into written text using known speech recognition techniques, such as speech-to-text conversion techniques, and then would send the text to the recipient's phone for display on the screen. As in the representative embodiments described above, if at any time the recipient wishes to engage in a two-way conversation, he or she may press a button and be connected.

An example of “silent screening” is illustrated on screen 408 of the wireless telephone 407. The subscriber may read the call screening transcript and may further choose from several selections. For example, by pressing “1” the subscriber may be automatically connected in a two-way call with the caller. Call screening may be stopped by pressing “2”. There may be further options to save the transcript in a compressed audio format or in a text file format. In addition, a saved transcript may be forwarded to another subscriber or to a centralized voice message storage location.

It should be noted that although “silent screening” is shown in FIG. 4 as being utilized with a wireless telephone, this is not representative of a limitation of the present invention. In various representative embodiments of the present invention, other devices may be used with the “silent screening” functionality. For example, a subscriber may be using a laptop computer (or a PDA device) at his home and a caller may call the subscriber's office telephone. “Silent screening” functionality may then be utilized on the subscriber's laptop so that a transcript of the caller's voice message that is being left at subscriber's office telephone is also displayed on the laptop computer. The subscriber may then have the option of connecting and talking with the caller utilizing, for example, an Internet connection between the laptop's speaker and microphone and the voice message network servicing the subscriber's office telephone.

It should be appreciated that, although voice mail is perhaps most commonly associated with mobile phones, embodiments of the present invention may have applicability to any type of phone (including mobile phones, traditional landline phones, and IP phones), as well as to any type of centralized voice mail system connected to any number of telephones.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of remote screening of calls in a centralized voice mail system, the method comprising:
(a) receiving an incoming call for a subscriber telephone;
(b) receiving a call screening enablement signal from the subscriber telephone;
(c) muting a voice signal from the subscriber telephone;
(d) recording the incoming call to a voice mailbox associated with the subscriber, while playing the incoming call to the subscriber telephone;
(e) terminating recording and initiating two-way communication between the incoming call and the subscriber telephone, if a call screening disablement signal is received; and
(f) continuing recording the incoming call to a voice mailbox associated with the subscriber while playing the incoming call to the subscriber telephone, if a call screening disablement signal is not received.

2. The method of claim 1 wherein the subscriber telephone comprises one of a conventional telephone, a cellular telephone, and an Internet protocol (IP) phone.

3. The method of claim 1 wherein the voice mailbox is located within the subscriber telephone.

4. A method of remote screening of calls in a centralized voice mail system, the method comprising:
(a) receiving an incoming call for a first subscriber telephone;
(b) alerting a second subscriber telephone of the incoming call;
(c) receiving a call screening enablement signal from the second subscriber telephone;
(c) muting a voice signal from the second subscriber telephone;
(d) recording the incoming call to a voice mailbox associated with the subscriber, while playing the incoming call to the second subscriber telephone;
(e) terminating recording and initiating two-way communication between the incoming call and the second subscriber telephone, if a call screening disablement signal is received; and
(f) continuing recording of the incoming call, if a call screening disablement signal is not received.

5. The method of claim 4 wherein the first subscriber telephone comprises one of a conventional telephone, a cellular telephone, and an Internet protocol (IP) phone.

6. The method of claim 4 wherein the second subscriber telephone comprises one of a conventional telephone, a cellular telephone, and an Internet protocol (IP) phone.

7. The method of claim 4 wherein the voice mailbox is located within the first subscriber telephone.

8. The method of claim 4 wherein the alerting comprises at least one of an audible and a visual alert.

9. A method of screening calls in a centralized voice mail system, the method comprising:
(a) receiving an indication of an incoming call for a voice mail system subscriber, the incoming call originating from a caller's telephone to a subscriber's telephone;
(b) accepting an indication from the subscriber that call screening of the incoming call is desired;
(c) routing the incoming call to be recorded in a subscriber's voice mail box as a caller's voice message; and
(d) initiating call screening of the caller's voice message by establishing a three-way connection between the caller's telephone, the subscriber's telephone, and the centralized voice mail system, and wherein voice signals from the subscriber's telephone are muted.

10. The method of claim 9, wherein the subscriber receives the indication of the incoming call on the subscriber's telephone.

11. The method of claim 9, wherein the subscriber receives the indication of the incoming call on a remote telephone.

12. The method of claim 11, wherein the three-way connection is established between the caller's telephone, the remote telephone, and the centralized voice mail system, and wherein voice signals from the remote telephone are muted.

13. The method of claim 9, wherein the subscriber receives the indication of the incoming call via the Internet.

14. The method of claim 9, wherein the indication of the incoming call is at least one of a visual indication and an audible indication.

15. The method of claim 9, wherein the subscriber's voice mail box is part of a functionality present on the subscriber's telephone.

16. The method of claim 9, wherein the subscriber's voice mail box is part of a functionality present on the remote telephone.

17. The method of claim 16, further comprising:
(e) storing the caller's voice message as an audio file in the subscriber's voice mail box on the remote telephone; and
(f) transferring the audio file from the subscriber's voice mail box on the remote telephone to a voice message storage location on the centralized voice message system, the audio file being accessible for subsequent review by the subscriber.

18. The method of claim 17, wherein the caller's voice message is automatically recorded in the subscriber's voice mail box without initiating the call screening, the automatic recordation based on at least one of the caller's name and the caller's telephone number.

19. The method of claim 9, wherein the indication of the incoming call comprises at least one of the caller's name and the caller's telephone number.

20. The method of claim 19, wherein call screening of the incoming call is initiated automatically based on at least one of the caller's name and the caller's telephone number.

21. The method of claim 9, wherein the three-way connection is established using at least one of a wired network connection and a wireless network connection.

22. The method of claim 9, further comprising:
(e) initiating a two-way call between the caller and the subscriber by removing the centralized voice mail system from the three-way connection and un-muting the subscriber's telephone, the initiating of the two-way call being at the subscriber's choice.

23. The method of claim 9, further comprising:
(e) interrupting call screening of the caller's voice message by removing the subscriber's telephone from the three-way connection, the removing of the subscriber's telephone being at the subscriber's choice; and
(f) saving the caller's voice message in the subscriber's voice mail box for subsequent access by the subscriber.

24. The method of claim 9, wherein during the call screening, the caller's voice message is an audible message heard on the subscriber's telephone.

25. The method of claim 9, wherein during the call screening, the caller's voice message is converted from speech to text.

26. The method of claim 25, wherein the text is displayed on the subscriber's telephone.

27. A method of remote screening of calls in a centralized voice mail system, the method comprising:
(a) receiving an incoming call to a voice mail system subscriber, the call originating from a caller's telephone to the subscriber's telephone, the subscriber being already engaged in an existing conference call on the subscriber's telephone;
(b) initiating a recording of the incoming call as a caller's voice message into a subscriber's voice mail box;
(c) converting the caller's voice message from speech to text, the conversion being performed during the recording of the caller's voice message;
(d) displaying the converted text message on the subscriber's telephone, the displaying being performed during the conversion of the caller's voice message;
(e) initiating a two-way call between the caller and the subscriber, the initiating of the two way call being at the subscriber's choice; and
(f) initiating a recording of the existing conference call into the subscriber's voice mail box, the initiating of the recording being performed automatically after initiating the two-way call.

28. A system supporting the remote screening of calls, the system comprising:
at least one processor capable of receiving an incoming call for a subscriber telephone;
the at least one processor capable of receiving a call screening enablement signal from the subscriber telephone;
the at least one processor capable of muting a voice signal from the subscriber telephone;
the at least one processor capable of recording the incoming call to a voice mailbox associated with the subscriber, while playing the incoming call to the subscriber telephone;
the at least one processor capable of terminating recording and initiating two-way communication between the incoming call and the subscriber telephone, if a call screening disablement signal is received; and
the at least one processor capable of continuing recording the incoming call to a voice mailbox associated with the subscriber while playing the incoming call to the subscriber telephone, if a call screening disablement signal is not received.

29. The system of claim 28 wherein the subscriber telephone comprises one of a conventional telephone, a cellular telephone, and an Internet protocol (IP) phone.

30. The system of claim 28 wherein the voice mailbox is located within the subscriber telephone.

31. A system supporting the remote screening of calls, the system comprising:
at least one processor capable of receiving an incoming call for a first subscriber telephone;
the least one processor capable of alerting a second subscriber telephone of the incoming call;
the least one processor capable of receiving a call screening enablement signal from the second subscriber telephone;
the least one processor capable of muting a voice signal from the second subscriber telephone;
the least one processor capable of recording the incoming call to a voice mailbox associated with the subscriber, while playing the incoming call to the second subscriber telephone;
the least one processor capable of terminating recording and initiating two-way communication between the incoming call and the second subscriber telephone, if a call screening disablement signal is received; and
the least one processor capable of continuing recording of the incoming call, if a call screening disablement signal is not received.

32. The system of claim 31 wherein the first subscriber telephone comprises one of a conventional telephone, a cellular telephone, and an Internet protocol (IP) phone.

33. The system of claim 31 wherein the second subscriber telephone comprises one of a conventional telephone, a cellular telephone, and an Internet protocol (IP) phone.

34. The system of claim 31 wherein the voice mailbox is located within the first subscriber telephone.

35. The system of claim 31 wherein the alerting comprises at least one of an audible and a visual alert.
